(19) United States
(12) Patent Application Publication
(10) Pub. No.: US 2011/0317299 A1
(43) Pub. Date: Dec. 29, 2011

(54) MAGNETIC RECORDING MEDIUM AND DISK DEVICE

(75) Inventors: Yusuke KUBOTA, Ome-shi (JP); Hiroyuki Suzuki, Ome-shi (JP); Hiroshi Kubota, Fussa-shi (JP); Satoshi Kuwahara, Kawasaki-shi (JP)

(73) Assignee: Kabushiki Kaisha Toshiba, Tokyo (JP)

(21) Appl. No.: 13/163,426

(22) Filed: Jun. 17, 2011

(30) Foreign Application Priority Data
Jun. 29, 2010 (JP) 2010-148320

(51) Int. Cl. G11B 5/86

(52) U.S. Cl. 360/15; G9B/5.308

(57) ABSTRACT

According to one embodiment, a magnetic recording medium on which servo data is recorded by magnetic transfer recording, the medium includes a data recording area in which data is recorded on a plurality of data tracks extending in form of concentric circles, and a servo area comprising the servo data corresponding to the data tracks. The servo data includes a plurality of burst patterns for tracking detection, which are arranged in a circumferential direction of the data tracks, and the burst patterns comprise a number of recording crests which differs depending on a radial position on the magnetic recording medium.

### CROSS-REFERENCE TO RELATED APPLICATIONS

This application is based upon and claims the benefit of priority from Japanese Patent Application No. 2010-148320, filed Jun. 29, 2010; the entire contents of which are incorporated herein by reference.

### FIELD

Embodiments described herein relate generally to a magnetic recording medium which records servo data, and to a disk device.

### BACKGROUND

Magnetic disks as recording media used for magnetic disk devices each comprise a data recording area and a servo data area. The data recording area includes data tracks which are formed coaxially. Servo data for each of the data tracks is recorded in advance in the servo data area.

In general, a multi-stack-servo write schema and a self-servo write schema are employed in servo data recording onto a magnetic disk. According to the multi-stack-servo write schema, servo data is written to pluial magnetic disks all at once, with the magnetic disks stacked on a spindle. According to the self-servo write schema, a magnetic disk is built in a magnetic disk device in which servo data is written to the magnetic disk by a magnetic head of the device itself inside the device. In any of the foregoing schemas, a magnetization direction in servo data writing has an angle corresponding to a skew angle of a head, depending on a radial position of a magnetic disk. The magnetic disk to which servo data has thus been written has a magnetization direction which is substantially equal to the skew angle of the head used in the magnetic disk device. An angle (azimuth angle) between the magnetization direction and the head is small. Therefore, the servo data can be read excellently, and the output from the head decreases little.

Another known recording schema for servo data is a magnetic-transfer recording schema in which servo data is recorded on a magnetic disk by transferring magnetic data to the magnetic disk from a master magnetic recording disk. In this magnetic-transfer recording schema, servo data is not written by a magnetic head which is compatible with an actual disk device during servo data recording but the magnetic disk is magnetized by a master magnetic recording disk. At this time, if the magnetization direction is an in-plane direction, the magnetization direction of the servo data becomes a constant direction which is vertical to a radial direction, independently from radial positions on the magnetic disk. According to the magnetic-transfer recording schema, magnetic disks can be manufactured at lower costs in a shorter time than according to the multi-stack-servo write schema and self-servo write schema.

However, when a magnetic disk to which servo data has been written by the magnetic-transfer recording schema as described above is used in a magnetic disk device, an azimuth angle is formed between a magnetization direction of the servo data and a magnetic head, due to a head skew angle in the device. If the azimuth angle is large, an output obtained from the magnetic head which has read magnetic data decreases, thereby decreasing the signal-to-noise ratio of the servo data. This phenomenon causes a reduction in positioning accuracy and data reading accuracy of the magnetic head with respect to data tracks of the magnetic disk.

Particularly in the magnetic-transfer recording method in which data is magnetically written to a magnetic disk by horizontally applying a magnetic field in a circumferential direction of the disk, magnetization efficiency is maximum at a direction vertical to a magnetic field direction, i.e., by a magnetization pattern parallel to a radial direction. When an azimuth angle is formed in a magnetization direction or particularly when a phase pattern is used, the signal-to-noise ratio of a reproduced signal from a magnetization pattern decreases conspicuously. Such a decrease of signal-to-noise ratio of a reproduced signal is a factor which reduces the positioning accuracy required for a large-volume magnetic disk device.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary plan view schematically showing a magnetic disk and a head, according to a first embodiment.

FIG. 2 is an enlarged exemplary plan view schematically showing a part of the magnetic disk;

FIG. 3 is an exemplary plan view showing data tracks of the magnetic disk;

FIG. 4 is an exemplary plan view schematically showing servo data in an intermediate peripheral area of the magnetic disk;

FIG. 5 is an exemplary plan view schematically showing servo data in an outer peripheral area of the magnetic disk;

FIG. 6A is an exemplary plan view schematically showing bursts of the servo data in the inner peripheral area of the magnetic disk;

FIG. 6B is an exemplary graph showing a read output from the bursts;

FIG. 7A is an exemplary plan view schematically showing bursts of the servo data in the outer peripheral area of the magnetic disk;

FIG. 7B is an exemplary graph showing a read output from the bursts;

FIG. 8 is an exemplary plan view schematically showing bursts of servo data in an intermediate peripheral area of a magnetic disk, according to a second embodiment;

FIG. 9 is an exemplary plan view schematically showing bursts of servo data in an outer peripheral area of the magnetic disk, according to the second embodiment;

FIG. 10 is an exemplary perspective view showing a hard disk drive according to another embodiment;

FIG. 11 is an exemplary block diagram schematically showing a configuration of the HDD;

FIG. 12 is an exemplary flowchart showing a control operation of changing a read setting for a number of burst crests in the HDD; and

FIG. 13 is an exemplary flowchart showing another control operation of changing a read setting for a number of burst crests in the HDD.

### DETAILED DESCRIPTION

Various embodiments will be described hereinafter with reference to the accompanying drawings.

In general, according to one embodiment, a magnetic recording medium on which servo data is recorded by magnetic transfer recording, the medium comprises a data recording area in which data is recorded on a plurality of data tracks extending in form of concentric circles; and a servo area comprising the servo data corresponding to the data tracks. The servo data comprises a plurality of burst patterns for tracking detection, which are arranged in a circumferential direction of the data tracks, and the burst patterns comprise a number of recording crests which differs depending on a radial position on the magnetic recording medium.

Hereinafter, descriptions will be made of a magnetic recording medium and a magnetic disk device comprising the recording medium according to each of the embodiments.

### First Embodiment

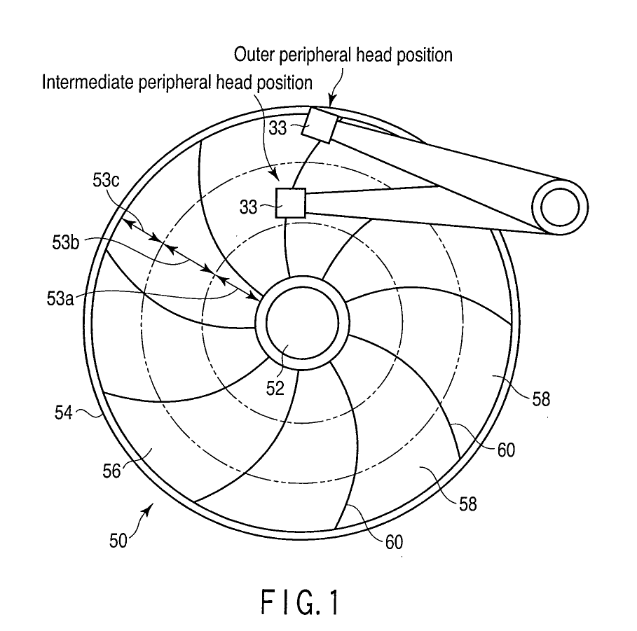

As shown in FIG. 1, a magnetic disk 50 according to the first embodiment comprises a flat disk-type substrate 54 and a recording layer 56. The substrate 54 comprises a center hole 52. The recording layer 56 is formed on at least one of surfaces of the substrate, e.g., recording layers 56 formed on top and back surfaces of the substrate. The substrate 54 is formed of, for example, glass, and a soft underlayer (SUL) is formed on each of the top and back surfaces of the substrate 54. The substrate 54 is not limited to glass but may be formed of aluminum. The recording layers 56 are layered on the soft underlayers. A protect film is formed on each of the surfaces of the magnetic disk, and LUB is further coated as a lubricant thereon. In this manner, the magnetic disk 50 is constituted comprising flattened surfaces for vertical magnetic recording.

The recording layers 56 forming recording areas are each formed in a ring shape which is coaxial to the substrate. The recording layers 56 are formed of a ferromagnetic material, e.g., CoCrPt. Each of the recording areas of the magnetic disk 50 comprises or, in other words, is roughly divided into a data recording area 58 and plural servo areas 60.

As shown in FIG. 1, depending on radial positions, the magnetic disk 50 is divided into, for example, an inner peripheral area 53a positioned in an inner peripheral side, an intermediate peripheral area 53b positioned in the middle in radial directions, and an outer peripheral area 53c positioned in an outer peripheral side. The areas 53a, 53b, and 53c each are formed in a ring shape which is coaxial with a center of the magnetic disk. FIG. 1 schematically shows a magnetic head 33 which performs data processing on the magnetic disk 50 where the magnetic disk 50 is built in the magnetic disk device. Although the magnetic disk 50 is divided into three areas arranged in radial directions, the magnetic disk 50 may be more finely divided depending on radial positions.

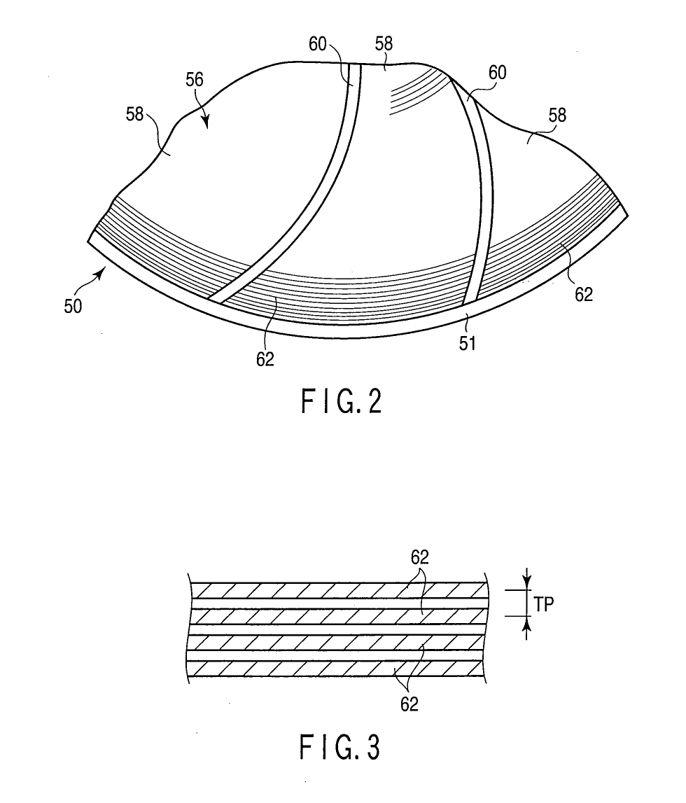

As shown in FIGS. 2 and 3, the data recording areas 58 each form an area where user data is recorded/reproduced onto/from by the magnetic heads 33 described later, which are provided in the magnetic disk device. Each data recording area 58 comprises plural data tracks 62 each formed in a ring shape. The data tracks 62 are formed to be substantially coaxial with the center hole 52 at a constant cycle in the radial directions of the substrate 54, i.e., arranged at a constant track pitch Tp.

As shown in FIGS. 1 and 2, the data tracks 62 formed in each of the data recording areas 58 are each divided into sectors along a circumferential direction of the substrate 54 by the plural servo areas 60. In the figures, the data recording area 58 is divided into nine sectors. In actual, however, the data tracks 62 each are divided into one hundred sectors or more. Each of the servo areas 60 is a pre-bit area which records data required for positioning the magnetic heads 33 of the magnetic disk device in relation to the magnetic disk 50. Each of the servo areas 60 is formed in an arcuate shape which corresponds to a locus of movement of the heads.

The magnetic disk 50 is constituted as a magnetic-transfer recording type. That is, magnetic data including servo data is recorded by transferring the magnetic data onto the recording layers 56 of the magnetic disk 50 from an original magnetic recording disk (or a master disk). A magnetization direction of the servo data is a constant direction which is vertical to the radial directions, independently from radial positions of the magnetic disk 50.

Next, a servo pattern for the servo areas 60 will be described in details below.

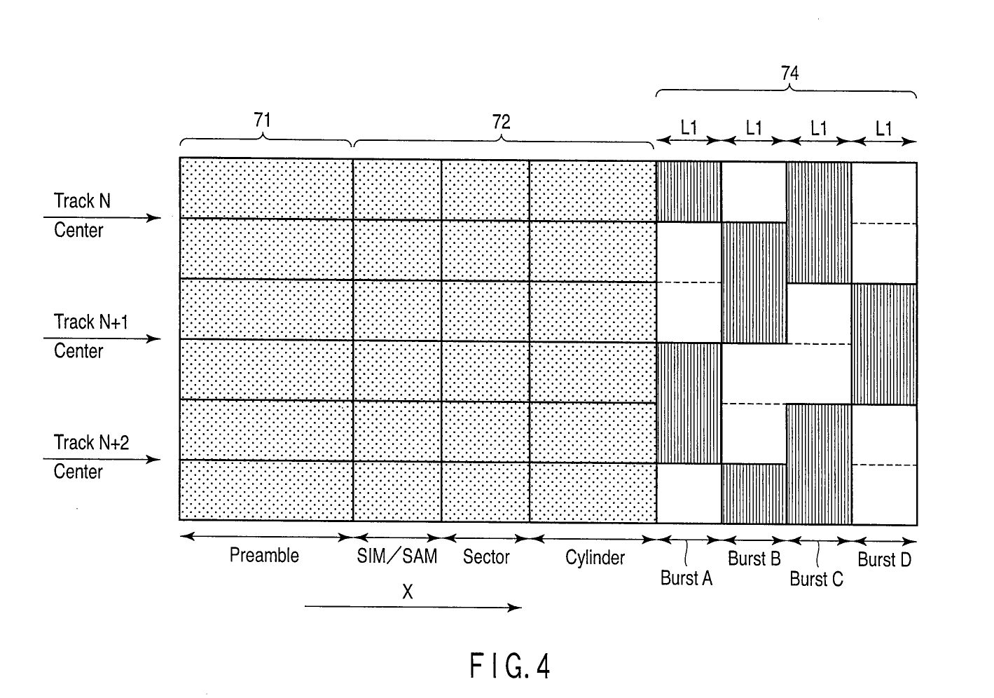

FIG. 4 shows a servo data pattern of a servo area 60 provided for the data tracks 62 in the intermediate peripheral area 53b of the magnetic disk 50. Where the magnetic disk 50 is built in a drive, the servo data pattern is a place which a head passes over along a passing direction X from the left side to the right in the figure. In each of the left and right sides of the servo area 60, a data recording area as described above is provided.

The servo data pattern is constituted by or, in other words, roughly divided into a preamble part 71, an address part 72, and a burst part 74 for detecting a tracking deviation, which are arranged in the circumferential direction.

The preamble part 71 is provided for performing PLL processing and AGC processing. The PLL processing is to synchronize a servo signal reproduction clock with a time offset caused by rotational deviation of the magnetic disk 50. The AGC processing is to properly maintain a reproduced signal amplitude. The preamble part 71 continues at least in a substantially arcuate radial direction of the recording layer 56, and is formed as a repetitive pattern area where the magnetization direction is repeatedly inverted along the circumferential direction of the substrate.

In the address part 72, a servo index mark and a servo address mark (SIM/SAM) which are called servo marks, sector data, and cylinder data are formed at the same pitch as the circumferential pitch of the preamble part 71 by Manchester code. A SIM/SAM pattern thereof varies between the inner peripheral area 53a, intermediate peripheral area 53b, and outer peripheral area 53c, depending on radial positions on the magnetic disk 50, as will be described later.

The cylinder data is a pattern, data of which varies for each data track. Therefore, code conversion to Grey code, which minimizes variation from an adjacent track, is performed and is then recorded as Manchester code, in order to reduce the influence of address read errors during a head seek operation.

The burst part 74 is a tracking detection area for detecting an off-track amount of the cylinder address from an on-track state thereof, and comprises four area servo patterns, which are referred to as bursts A, B, C, and D. The area servo patterns are according to an amplitude detection schema, and are also called amplitude servo patterns. Bursts A, B, C, and D are formed, arranged in the circumferential direction, and shifted in the radial directions by a half track pitch from each other, in relation to the data tracks 62. Bursts A, B, C, and D have equal lengths L1 in the circumferential direction.

Each of bursts A, B, C, and D is formed in a pattern which has a predetermined number of crests in the circumferential direction. The number of crests implies a number of signals which are included in each of bursts A, B, C, and D and have substantially equal cycles. Patterns of bursts A, B, C, and D are formed at the same pitch cycle as the pattern of the preamble part 71. A radial cycle is proportional to a variation cycle of an address pattern, or in other words, at a cycle proportional to a data track cycle. In the present embodiment, the patterns of bursts A, B, C, and D each comprise a number of crests which differs depending on radial positions on the magnetic disk 50. Here, the number of crests in each of the patterns differs between the inner peripheral area 53a, intermediate peripheral area 53b, and outer peripheral area 53c.

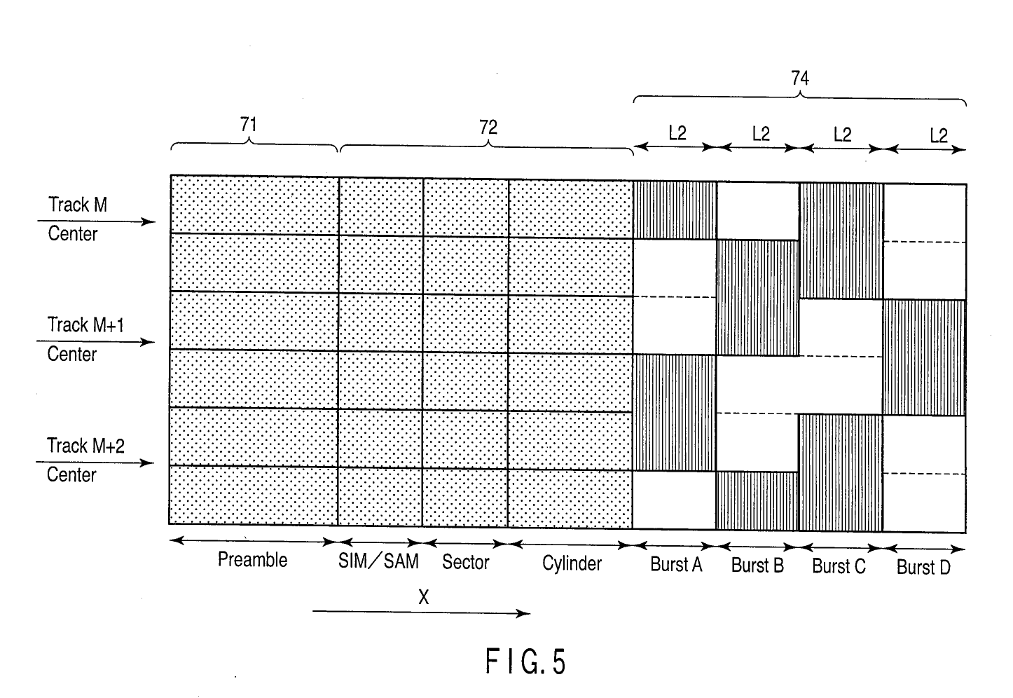

FIG. 5 shows a servo data pattern of a servo area 60 provided for the data tracks 62 in the inner peripheral area 53a of the magnetic disk 50. The servo data pattern comprises a preamble part 71, an address part 72, and a burst part 74 for detecting a tracking deviation, which are arranged in the circumferential direction and are each constituted by a magnetic pattern.

The preamble part 71, address part 72, and burst part 74 are formed in the same manner as in the servo data pattern in the intermediate peripheral area 53b as described previously. However, SIM/SAM patterns differ between the inner peripheral area 53a, intermediate peripheral area 53b, and outer peripheral area 53c. In the inner peripheral area 53a, bursts A, B, C, and D in the burst part 74 have substantially equal lengths L2 which are greater than lengths L1 of the bursts in the intermediate peripheral area 53b (L2>L1).

The patterns of bursts A, B, C, and D each are formed to have a greater number of recording crests than the patterns in the intermediate peripheral area 53b. In the inner peripheral area 53a, the number of recording crests in each burst pattern is increased from the number of recording crests in the intermediate peripheral area 53b, as a reference, in a manner that positioning accuracy and signal-to-noise ratio which are substantially equivalent to those of the intermediate peripheral area are obtained. The number of recording crests in the pattern of each of bursts A, B, C, and D in the inner peripheral area 53a is set to 1.2 to 1.5 times greater than that of the pattern of each of bursts A, B, C, and D in the intermediate peripheral area 53b.

A servo data pattern in the outer peripheral area 53c of the magnetic disk 50 is formed in the same manner as the servo data pattern in the inner peripheral area 53a as shown in FIG. 5. That is, bursts A, B, C, and D are formed to have substantially equal lengths L2 which are greater than lengths L1 of the bursts in the intermediate peripheral area 53b (L2>L1).

The patterns of bursts A, B, C, and D each are formed to have a greater number of recording crests than the burst patterns in the intermediate peripheral area 53b. In the outer peripheral area 53c, the number of recording crests in each burst pattern is increased from the number of recording crests in the intermediate peripheral area 53b, as a reference, in a manner that positioning accuracy and the signal-to-noise ratio which are substantially equivalent to those of the intermediate peripheral area are obtained. The number of recording crests in the pattern of each of bursts A, B, C, and D in the outer peripheral area 53a is set to 1.2 to 1.5 times greater than that of the pattern of each of bursts A, B, C, and D in the intermediate peripheral area 53b.

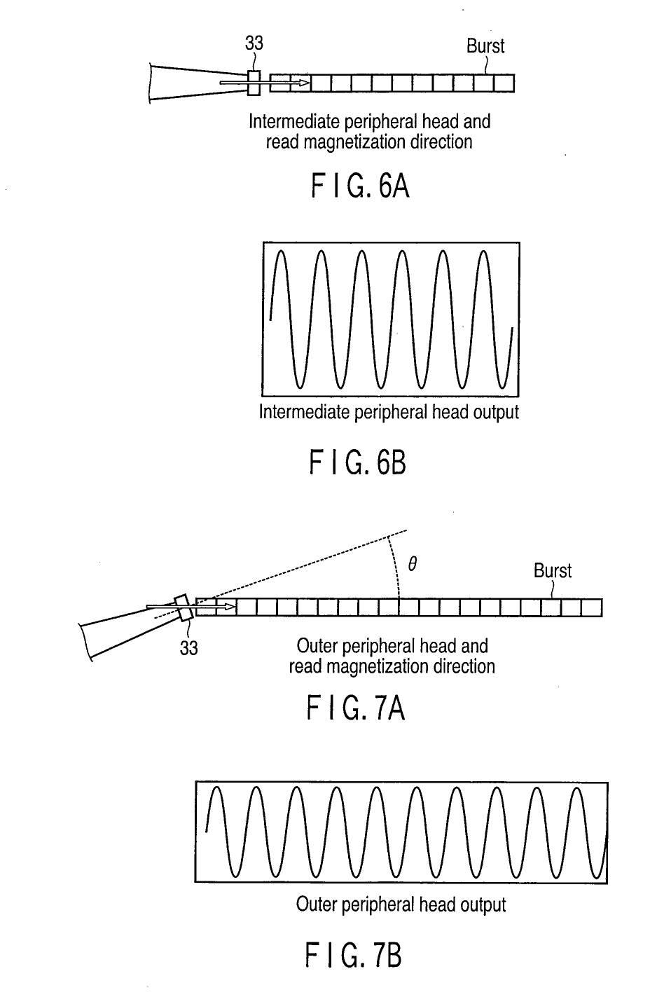

FIG. 6A shows a positional relationship between the magnetic head 33 and burst patterns in the intermediate peripheral area 53b of the magnetic disk 50. FIG. 6B shows a read output from the magnetic head 33. FIG. 7A shows a positional relationship between the magnetic head 33 and burst patterns in the outer peripheral area 53c of the magnetic disk 50. FIG. 7B shows a read output from the magnetic head 33.

As shown in FIG. 6A, in the intermediate peripheral area 53b, the magnetic heads 33 each do not substantially form any azimuth angle to the servo data pattern but accurately reads the servo data pattern including bursts A, B, C, and D. Accordingly, a head output with a satisfactory amplitude can be obtained as shown in FIG. 6B. Depending on the head output, the magnetic heads can be positioned with high accuracy in relation to the data tracks 62.

In contrast, as shown in FIG. 7A, the magnetic heads 33 each form an azimuth angle θ in the outer peripheral area 53c and inner peripheral area 53a (wherein the azimuth angle θ is inverted between the outer and inner peripheral sides). Consequently, the read output from the magnetic heads 33 decreases as shown in FIG. 7B. According to the present embodiment, however, each of bursts A, B, C, and D of the servo data pattern in the outer peripheral area 53c and inner peripheral area 53a has a greater number of recording crests than bursts A, B, C, and D in the intermediate peripheral area 53b. Therefore, the magnetic head 33 outputs more read signals, and the signal-to-noise ratio of read signals can be improved. In this manner, even when the magnetic head 33 forms an azimuth angle θ to the servo data patterns in the inner peripheral area 53a and outer peripheral area 53c, signal-to-noise ratio loss of servo data can be compensated for, and reduction in positioning accuracy of the magnetic head can be suppressed. Accordingly, there is provided a magnetic recording medium which can contribute to achievement of high positioning accuracy required for a large-volume disk device.

### Second Embodiment

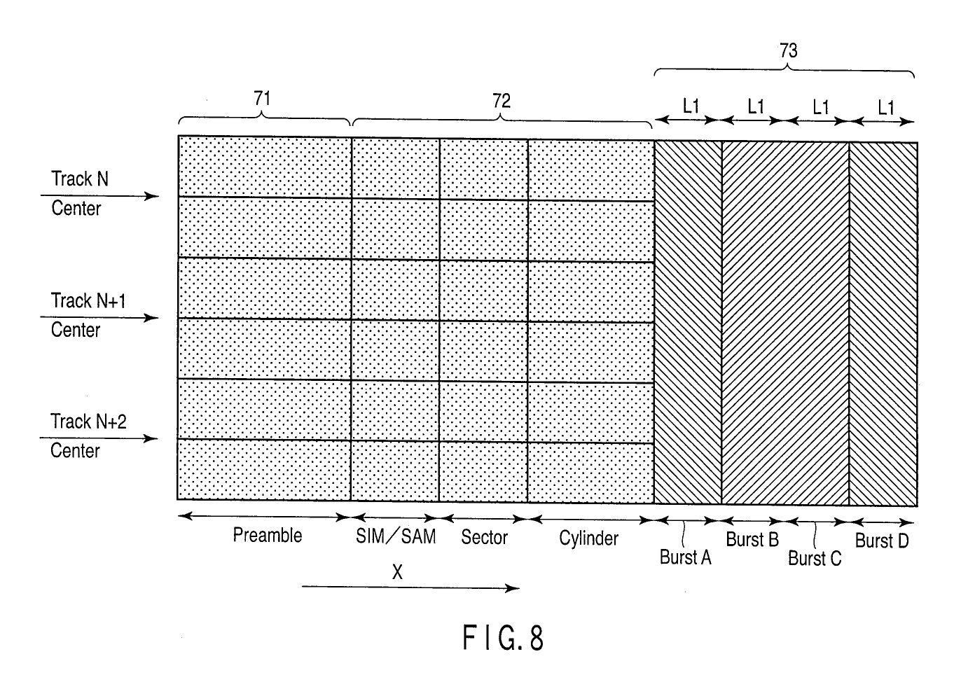

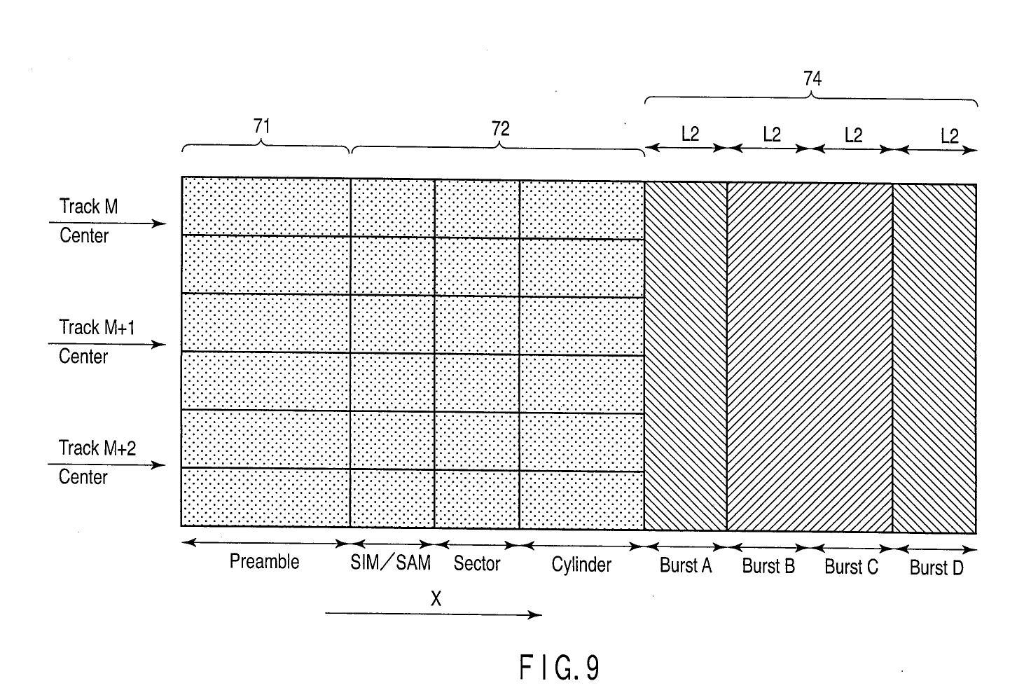

In the embodiment described above, the bursts in the servo data patterns of the magnetic disk are constituted as area-type servo patterns. However, the bursts are not limited to this configuration but may be constituted as phase-type servo patterns. FIG. 8 shows a servo data pattern in an intermediate peripheral area of a magnetic disk according to the second embodiment. FIG. 9 shows a servo data pattern in an inner or outer peripheral area of the magnetic disk according to the second embodiment.

As shown in FIG. 8, according to the second embodiment, a servo data pattern provided for data tracks in an intermediate peripheral area 53b of a magnetic disk 50 comprises a preamble part 71, an address part 72, and a burst part 74 for detecting a tracking deviation, which are arranged in a circumferential direction.

The preamble part 71 and address part 72 are formed in the same manner as in the first embodiment described above. The burst part 74 comprises four bursts A, B, C, and D which are arranged continuously in the circumferential direction. Each of bursts A, B, C, and D is formed as a phase servo pattern constituted by oblique lines, and continues in a substantially arcuate radial direction of the magnetic disk 50. Bursts A, B, C, and D have equal lengths L1 in the circumferential direction. Each of bursts A, B, C, and D is formed in a pattern in which a predetermined number of recording crests are formed, for example, at the same pitch cycle in the circumferential direction as in the preamble part. The patterns of bursts A, B, C, and D each have a number of recording crests which differs depending on radial positions on the magnetic disk 50. Here, the number of crests in each of the patterns differs between the inner peripheral area 53a, intermediate peripheral area 53b, and outer peripheral area 53c.

FIG. 9 shows a servo data pattern in a servo area 60 provided for the data tracks 62 in the inner peripheral area 53a of the magnetic disk 50. The servo data pattern comprises a preamble part 71, an address part 72, and a burst part 74 for detecting a tracking deviation, which are arranged in the circumferential direction and are each constituted by a magnetic pattern.

The preamble part 71, address part 72, and burst part 74 are formed in the same manner as in the servo data pattern in the intermediate peripheral area 53b as described previously. However, SIM/SAM patterns differ between the inner peripheral area 53a, intermediate peripheral area 53b, and outer peripheral area 53c.

As shown in FIG. 9, in the inner peripheral area 53a, bursts A, B, C, and D in the burst part 74 have substantially equal lengths L2 which are greater than lengths L1 of the bursts in the intermediate peripheral area 53b (L2>L1).

The patterns of bursts A, B, C, and D each are formed to have a greater number of recording crests than the patterns in the intermediate peripheral area 53b. In the inner peripheral area 53a, the number of recording crests in each burst pattern is increased from the number of recording crests in the intermediate peripheral area 53b, as a reference, in a manner that positioning accuracy and signal-to-noise ratio which are substantially equivalent to those of the intermediate peripheral area are obtained. The number of recording crests in the pattern of each of bursts A, B, C, and D in the inner peripheral area 53a is set to 1.2 to 1.5 times greater than that of the pattern of each of bursts A, B, C, and D in the intermediate peripheral area 53b.

A servo data pattern in the outer peripheral area 53c of the magnetic disk 50 is formed in the same manner as the servo data pattern in the inner peripheral area 53a as shown in FIG. 9. That is, bursts A, B, C, and D are formed to have substantially equal lengths L2 which are greater than lengths L1 of the bursts in the intermediate peripheral area 53b (L2>L1).

The patterns of bursts A, B, C, and D each are formed to have a greater number of recording crests than the bursts in the intermediate peripheral area 53b. In the outer peripheral area 53c, the number of recording crests in each burst pattern is increased from the number of recording crests in the intermediate peripheral area 53b, as a reference, in a manner that positioning accuracy and signal-to-noise ratio which are substantially equivalent to those of the intermediate peripheral area are obtained. The number of recording crests in the pattern of each of bursts A, B, C, and D in the outer peripheral area 53a is set to 1.2 to 1.5 times greater than that of the pattern of each of bursts A, B, C, and D in the intermediate peripheral area 53b.

In the second embodiment except for features as described above, the magnetic disk has the same configuration as in the first embodiment described above. Also according to the second embodiment, the same operation and effects as the first embodiment can be obtained.

Next, an embodiment of a hard disk drive (HDD) comprising any of the magnetic disks 50 described above will be specifically described as a magnetic disk device.

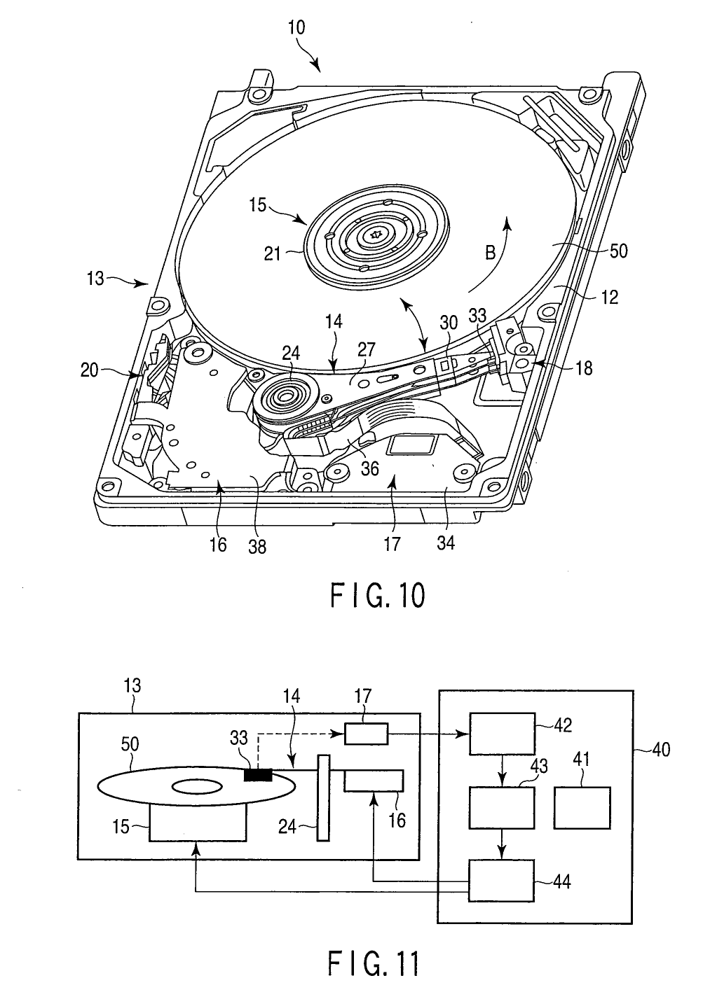

As shown in FIGS. 10 and 11, an HDD 10 comprises a flat rectangular casing 13. The casing 13 comprises a base 12 having a box-like shape, and an unillustrated top cover which closes tightly an opening part in a top surface of the base 12.

Provided on the base 12 are the magnetic disk 50 described above, a spindle motor 15, plural magnetic heads 33, a head actuator 14, and a voice coil motor (VCM) 16. The spindle motor 15 supports and rotates the magnetic disk. The plural magnetic heads 33 record/reproduce data onto/from the magnetic disk. The head actuator 14 supports the magnetic heads 33 to be freely movable in relation to the magnetic disk 50. The VCM 50 pivots and positions the head actuator 14. Also provided on the base 12 are a ramp load mechanism 18, an inertial latch mechanism 20, and a flexible printed-circuit board unit (hereinafter FPC unit) 17. The ramp load mechanism 18 maintains the magnetic heads 33 at a position apart from the magnetic disk when the magnetic heads 33 are moved to outermost periphery of the magnetic disk 50. The inertial latch mechanism 20 maintains the head actuator 14 at a retracted position. The FPC unit 17 is equipped with circuit components such as a preamplifier, etc.

As described previously, the magnetic disk 50 is a magnetic recording medium on which magnetic data is written according to the magnetic-transfer recording schema. For example, the magnetic disk 50 is formed to have a diameter of 1.8 or 2.5 inches. The magnetic disk 50 is engaged coaxially with an unillustrated hub of the spindle motor 15, and is secured to the hub by a clamp spring 21. The magnetic disk 50 is supported by the spindle motor 15 as a drive section, and is rotated at a predetermined speed in an arrow direction B.

The head actuator 14 comprises a bearing part 24, two arms 27, and suspensions 30. The bearing part 24 is secured to the bottom wall of the base 12. The two arms 27 are attached to a bearing assembly of the bearing part 24. The suspensions 30 respectively extend from the arms. The magnetic heads 33 are supported at distal ends of the suspensions 30. The arms 27, suspensions 30, and magnetic heads 33 are supported to freely rotate about the bearing part 24. The magnetic heads 33 are respectively provided with a down head and an up head. The down head faces a top-surface recording layer of the magnetic disk 50. The up head faces a back-surface recording layer. Each of the magnetic heads 33 comprises a slider and a magnetic head element which comprises a read element (GMR element) and a write element and is formed on the slider.

The VCM 16 comprises a voice coil, a pair of yokes 38, and an unillustrated magnet. The voice coil is provided on the head actuator 14. The pair of yokes 38 are secured to the base 12 and face the voice coil. The magnet is secured to one of the yokes. The VCM 16 generates rotational torque on an arm 27 about a bearing part 24, and moves the magnetic heads 33 in a radial direction of the magnetic disk 50.

The FPC unit 17 comprises a rectangular substrate body 34 secured to a bottom wall of the base 12. Plural electronic components and connectors are mounted on the substrate body. The FPC unit 17 comprises a main flexible-printed-circuit board 36 having a band shape. Each of the magnetic heads 33 supported by the head actuator 14 is electrically connected to the FPC unit 17 through an unillustrated relay FPC provided on the arms 27 and through the main flexible-printed-circuit board 36.

The magnetic disk 50 is built in the base 12 in a manner that the top and back surfaces of the disk are aligned in a direction along which a locus of movement of each magnetic head 33 of the HDD 10 substantially corresponds to the arcuate shape of each servo area 60. Specifications of the magnetic disk 50 comply with outer and inner diameters and recording/reproducing characteristics which are adequate for the HDD 10.

The spindle motor 15, VCM 16, and printed-circuit board (PCB) 40 are secured to an outer surface of the bottom wall of the base 12 through the FPC unit 17, and face the bottom wall of the base.

As shown in FIG. 11, a large number of electronic components are mounted on the PCB 40. These electronic components mainly include four system LSIs, e.g., a disk controller (HDC) 41, a read/write channel IC 42, a MPU 43, and a motor driver IC. Mounted on the PCB 40 are a connector connectable to a connector of the FPC unit 17, and a main connector for connecting the HDD 10 to an electronic device such as a personal computer.

The MPU 43 is a controller for a drive system of the drive, and is configured to comprise a ROM, a RAM, a CPU, and a logic processor which constitute a head positioning control system according to the present embodiment. The logic processor is an operation processing section constituted by a hardware circuit and is used for high-speed operation processing. Operating software (firmware) is stored in the ROM, and the MPU controls the drive in accordance with the firmware.

The HDC 41 is an interface section in the HDD 10, which interfaces between the disk drive and a host system such as a personal computer, and exchanges data with the MPU 43, read/write channel IC 42, and motor driver IC 44. Thus, the HDC 41 controls the whole HDD 10.

The read/write channel IC 42 is a head signal processor relating to reading/writing, and is constituted by a circuit which switches channels of a head amplifier IC and processes recorded and reproduced signals in reading/writing. The motor driver IC 44 is a driver for driving the VCM 16 and spindle motor 15. The motor driver IC 44 controls driving of the spindle motor 15 so as to rotate constantly, and supplies the VCM with a VCM operation amount as a current value from the MPU 43, to drive the head actuator 14. The magnetic heads 33 read servo data from the magnetic disk 50, and provides the CPU 43 with the data.

A cylinder number or a radial position range which changes a read setting for a number of recording crests per burst, depending on radial positions on the magnetic disk 50, can be arbitrarily determined. The cylinder number or radial position range for switching a read setting for a number of recording crests per burst may be changed in a manner as follows. That is, plural SIM/SAM patterns are associated in advance with numbers of recording crests in burst patterns. A SIM/SAM pattern is determined by the magnetic heads 33, and a number of recording crests is changed to an associated number of recording crests. Data for switching a read setting for the number of recording crest per burst may be stored in the ROM or recorded on a system area of the magnetic disk 50. The read setting may be changed by reading such data at an arbitrary timing.

According to the present embodiment, data which associates SIM/SAM patterns for the magnetic disk 50 respectively with corresponding numbers of recording crests in burst patterns is stored as setting change data in the ROM. The MPU 43 detects a read output of servo data from the magnetic heads 33, and changes a read setting for the number of recording crests per burst, depending on radial positions of the magnetic disk 50, e.g., an inner peripheral area, an intermediate peripheral area, and an outer peripheral area.

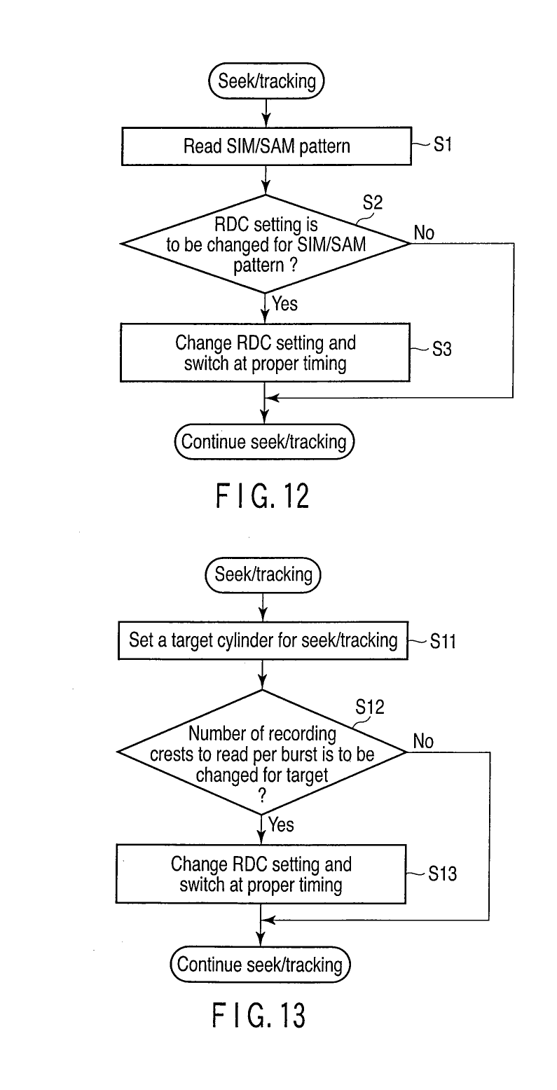

For example, as shown in FIG. 12, the MPU 43 reads a SIM/SAM pattern in a servo data pattern by the magnetic heads 33 during a seek operation or a tracking operation of the magnetic heads 33 (step 1), and determines the SIM/SAM pattern from a head output thereof. Further, the MPU 43 determines whether a read setting for the number of recording crests per burst (RDC setting: setting for the read/write channel IC 42) is to be changed or not, from the read SIM/SAM pattern and the setting change data stored in the ROM (step 2). If the read setting is determined to be changed, the MPU 43 changes, at a proper timing, the RDC setting to an associated number of recording crests to read, which corresponds to the SIM/SAM pattern (step 3). Further, the magnetic heads 33 read burst patterns, depending on the changed setting for the number of recording crests to read, and outputs a read signal. In this manner, even if the numbers of recording crests per burst differ depending on radial positions on the magnetic disk 50, the burst patterns each are steadily read for a predetermined number of recording crests per burst by the magnetic heads 33, and the signal-to-noise ratio of servo data can be improved.

Alternatively, the MPU 43 may control the number of recording crests to read according to a schema as shown in FIG. 13. That is, during a seek operation or a tracking operation of the magnetic heads 33, the MPU 43 sets a target cylinder of the magnetic disk 50 (step 11), and determines whether or not the target cylinder is a cylinder for which the number of recording crests to read from each burst is to be changed, based on data which associates cylinder numbers with numbers of recording crests per burst (step 12). If the target cylinder is determined to be a cylinder for which the numbers of recording crests to read is to be changed, the MPU 43 changes, at a predetermined timing, the RDC setting to an associated number of recording crests to read, which corresponds to the cylinder number. In this manner, even if the numbers of recording crests to read differ depending on radial positions on the magnetic disk 50, burst patterns each are steadily read for a predetermined number of recording crests by the magnetic heads 33 corresponding to a radial position, and the signal-to-noise ratio of servo data can be improved.

According to the HDD configured as described above, even when a magnetic disk of the magnetic transfer type is used, loss of servo data due to a low signal-to-noise ratio caused by an azimuth angle can be compensated for. Accordingly, reduction of magnetic head positioning accuracy caused by decreased head output can be suppressed. In this manner, head positioning accuracy increases, and there is provided a magnetic disk device capable of increasing a recording volume.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Although the above embodiments employ a magnetic disk of a vertical-magnetic recording type, the present invention is not limited to this type but is applicable also to a magnetic recording medium of a horizontal (in-plane) magnetic recording type. The invention is also applicable to a magnetic recording medium of a discrete track recording (DTR) type. Bursts of servo data are not limited to area patterns and phase patterns but may be other burst patterns such as Null patterns. Furthermore, a number of magnetic disks built into an HDD is not limited to one but may be increased according to necessity.

What is claimed is:

1. A magnetic recording medium on which servo data is recorded by magnetic transfer recording, the medium comprising:
a data recording area in which data is recorded on a plurality of data tracks extending in form of concentric circles; and
a servo area comprising the servo data corresponding to the data tracks, wherein
the servo data comprises a plurality of burst patterns for tracking detection, which are arranged in a circumferential direction of the data tracks, and the burst patterns comprise a number of recording crests which differs depending on a radial position on the magnetic recording medium.

2. The recording medium of claim 1, wherein
the servo area comprises an inner peripheral area, an intermediate peripheral area, and an outer peripheral area, which are arranged in a radial direction, and the number of recording crests in the burst patterns in the inner and outer peripheral areas is greater than the number of recording crests in the burst patterns in the intermediate peripheral area.

3. The recording medium of claim 2, wherein
a length of the burst patterns in the inner and outer peripheral areas in the circumferential direction is greater than a length of the burst patterns in the intermediate peripheral area in the circumferential direction.

4. The recording medium of claim 1, wherein
the plurality of burst patterns are formed as area servo patterns or phase servo patterns, the area servo patterns being arranged to be shifted from one another by a half track pitch in relation to the data tracks, and the phase servo patterns being constituted by oblique lines.

5. The recording medium of claim 1, wherein
the servo data comprises a servo index mark indicating an address of each of the data tracks, and the servo index mark has a pattern which differs depending on a radial position on the magnetic recording medium.

6. A disk device comprising:
a magnetic recording medium on which servo data is recorded by magnetic transfer recording, the medium comprising
a data recording area in which data is recorded on a plurality of data tracks extending in form of a concentric circle, and
a servo area comprising the servo data corresponding to the data tracks, wherein
the servo data comprises a plurality of burst patterns for tracking detection, which are arranged in a circumferential direction of the data tracks, and the burst patterns comprise a number of recording crests which differs depending on a radial position on the magnetic recording medium;
a drive module configured to support and rotate the magnetic recording medium;
a head configured to read the servo data from the magnetic recording medium;
a head actuator configured to move the head in relation to the magnetic recording medium; and
a controller configured to change a setting for reading the number of recording crests in the burst patterns, depending on the servo data.

7. The disk device of claim 6, wherein
the servo area comprises an inner peripheral area, an intermediate peripheral area, and an outer peripheral area, which are arranged in a radial direction, and the number of recording crests in the burst patterns in the inner and outer peripheral areas is greater than the number of recording crests in the burst patterns in the intermediate peripheral area.

8. The disk device of claim 7, wherein
a length of the burst patterns in the inner and outer peripheral areas in the circumferential direction is greater than a length of the burst patterns in the intermediate peripheral area in the circumferential direction.
